(19) United States
(12) Patent Application Publication
(10) Pub. No.: US 2025/0217031 A1
(43) Pub. Date: Jul. 3, 2025

(54) PORTABLE DISPLAY DEVICE

(71) Applicant: Samsung Display Co., LTD., Yongin-si (KR)

(72) Inventors: Joo Hyeon JEONG, Yongin-si (KR); Seung Rok LEE, Yongin-si (KR)

(21) Appl. No.: 18/910,797

(22) Filed: Oct. 9, 2024

(30) Foreign Application Priority Data
Dec. 27, 2023 (KR) 10-2023-0193528

(51) Int. Cl. G06F 3/04886; G06F 1/16; G06F 3/041; G06F 3/04817

(52) U.S. Cl. CPC G06F 3/04886; G06F 1/1652; G06F 3/0412; G06F 3/04817

(57) ABSTRACT

A portable display device includes: a display panel including planar display areas, and at least one folding area; a touch sensor on a front surface of the display panel to sense a user's touch; a touch driver circuit to: divide a touch sensing area of the touch sensor into planar sensing areas and at least a folding sensing area; and detect a touch position and a touch movement position on the planar sensing areas and the at least one folding sensing area to generate at least one touch coordinate data; and a display driver circuit to analyze a touch position, a touch movement direction, and a touch movement time on the planar sensing areas and the at least one folding sensing area to display icon or menu bar images on the display panel to enable the user to control a screen control function and an operation control function.

### CROSS-REFERENCE TO RELATED APPLICATION

The present application claims priority to and the benefit of Korean Patent Application No. 10-2023-0193528, filed on Dec. 27, 2023, in the Korean Intellectual Property Office, the entire disclosure of which is incorporated by reference herein.

### BACKGROUND

### 1. Field

Aspects of embodiments of the present disclosure relate to a portable display device.

### 2. Description of the Related Art

Display devices have become more and more important as multimedia technology evolves. Accordingly, a variety of types of display devices, such as organic light-emitting display (OLED) devices and liquid-crystal display (LCD) devices, are currently used.

Recently, mobility to display devices carried by users have become more desired. In particular, a variety of portable display devices that have performance comparable to desktop computers as well as mobile phones have recently been sold.

Portable display devices have decreased size and weight. Accordingly, users can perform a variety of features while moving about, such as watching videos and running office programs, as well as basic data transmission and reception functions. Therefore, it may be desirable to allow users to control devices more conveniently and accurately.

Recently, portable display devices include a variety of sensors, and perform operations pursuant to user's control actions. As such, the degree of recognition of users' motions and the sensitivity of the sensors have increased with the advancement of technology. Accordingly, improved performance of the interface features of display devices may be desired.

The above information disclosed in this Background section is for enhancement of understanding of the background of the present disclosure, and therefore, it may contain information that does not constitute prior art.

### SUMMARY

One or more embodiments of the present disclosure may be directed to a portable display device having improved user interface features by displaying icons or menu bars that allow a user to select or control built-in features according to the position of the user's touch/drawing operations.

One or more embodiments of the present disclosure may be directed to a portable display device that may control certain built-in features with only one-touch movement by sensing touch/drawing operations in a folding area and adjacent areas in a foldable display device.

However, the present disclosure is not limited to the above aspects and features, and the above and other aspects and features of the present disclosure will be apparent to those skilled in the art from the following description.

According to one or more embodiments of the present disclosure, a portable display device includes: a display panel including a plurality of planar display areas, and at least one folding area; a touch sensor on a front surface of the display panel to sense a user's touch; a touch driver circuit configured to: divide a touch sensing area of the touch sensor into a plurality of planar sensing areas and at least a folding sensing area; and detect a touch position and a touch movement position on the plurality of planar sensing areas and the at least one folding sensing area to generate at least one touch coordinate data; and a display driver circuit configured to analyze a touch position, a touch movement direction, and a touch movement time on the plurality of planar sensing areas and the at least one folding sensing area to display icon or menu bar images on the display panel to enable the user to control a screen control function and an operation control function of the display panel.

In an embodiment, the touch driver circuit may be configured to: divide the plurality of planar sensing areas overlapping with the planar display areas, respectively, the at least one folding sensing area overlapping with the at least one folding area, and a plurality of divided sensing areas of the plurality of planar sensing areas that is adjacent to the folding sensing area into sizes; and distinguish them from one another. Each of the divided sensing areas may be divided into an area or a size of 1/n of an area or a size of a corresponding planar sensing area from among the planar sensing areas, wherein n may be a positive integer.

In an embodiment, the display driver circuit may be configured to: analyze the at least one touch coordinate data to detect one touch or a number of multiple touches occurring concurrently with each other; analyze a touch position in the divided sensing area of each of the plurality of planar sensing areas for the one touch or each number of the multiple touches, a touch movement position, and a touch movement time between adjacent divided sensing areas; and display the icon or menu bar images on the display panel according to an analysis result of the touch movement position and the touch movement time between the adjacent divided sensing areas.

In an embodiment, the display driver circuit may be configured to: check the at least one touch coordinate data received from the touch driver circuit; and when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

In an embodiment, the display driver circuit may be configured to: detect the touch movement position and the touch movement time in the first divided sensing area by sequentially analyzing the touch coordinates of the first divided sensing area for one touch coordinate data generated by one touch in the first divided sensing area; check whether the touch position coordinates of a second divided sensing area of a second planar sensing area from among the planar sensing areas that is adjacent to the first divided sensing area are detected to detect the touch movement position and the touch movement time in the second divided sensing area; detect a first touch movement time, which may be a time interval between the touch movement time in the first divided sensing area and the touch movement time in the second divided sensing area; and determine a first interface command for the user when the first touch movement time is less than a reference time information to display a first screen menu on the display panel as the icon or menu bar images.

In an embodiment, the display driver circuit may be configured to: detect the touch movement position and the touch movement time in the first divided sensing area by sequentially analyzing the touch coordinates of the first divided sensing area for multiple touch coordinate data generated by multiple concurrent touches in the first divided sensing area; check whether the touch position coordinates of a second divided sensing area of a second planar sensing area from among the planar sensing areas that is adjacent to the first divided sensing area are detected to detect the touch movement position and touch movement time in the second divided sensing area; detect a second touch movement time, which may be a time interval between the touch movement time in the first divided sensing area and the touch movement time in the second divided sensing area; and determine a second interface command for the user when the second touch movement time is less than a reference time information to display a second screen menu on the display panel as the icon or menu bar images.

In an embodiment, the display driver circuit may be configured to: analyze the at least one touch coordinate data to detect one touch or a number of multiple touches occurring concurrently with each other; analyze a touch position in the plurality of planar sensing areas and the divided sensing area of each of the plurality of planar sensing areas for each of the one touch or the number of the multiple touches, a touch movement position, and a touch movement time between adjacent divided sensing areas; and display the icon or menu bar images on the display panel according to an analysis result of the touch movement position and the touch movement time between the adjacent divided sensing areas.

In an embodiment, the display driver circuit may be configured to: check the at least one touch coordinate data received from the touch driver circuit; and when touch position coordinates on a first planar sensing area from among the plurality of planar sensing areas and a first divided sensing area of the first planar sensing area are detected, check a number of touch position coordinates input and generated concurrently with each other to detect the one touch or the number of multiple touches that occurred concurrently with each other.

In an embodiment, the display driver circuit may be configured to: detect the touch movement position and the touch movement time in the first planar sensing area and the first divided sensing area by sequentially analyzing the touch coordinates connected to the first planar sensing area and the first divided sensing area for touch coordinate data generated by one touch in the first planar sensing area; check whether the touch position coordinates of a second planar sensing area adjacent to the first planar sensing area and a second divided sensing area of the second planar sensing area are detected to detect the touch movement position and touch movement time connected to the second planar sensing area and the second divided sensing area; detect a third touch movement time, which may be a time interval between the touch movement time in the first planar sensing area and the first divided sensing area and the touch movement time in the second planar sensing area and the second divided sensing area; and determine a third interface command for the user when the third touch movement time is less than a reference time information to display a third screen menu on the display panel as the icon or menu bar images.

In an embodiment, the display driver circuit may be configured to: detect the touch movement position and the touch movement time in the first planar sensing area and the first divided sensing area by sequentially analyzing the touch coordinates connected to the first planar sensing area and the first divided sensing area for multiple touch coordinate data generated by multiple concurrent touches in the first planar sensing area; check whether the touch position coordinates of a second planar sensing area adjacent to the first planar sensing area and a second divided sensing area of the second planar sensing area are detected to detect the touch movement position and the touch movement time connected to the second planar sensing area and the second divided sensing area; detect a fourth touch movement time, which may be a time interval between the touch movement time in the first planar sensing area and the first divided sensing area and the touch movement time in the second planar sensing area and the second divided sensing area; and determine a fourth interface command for the user when the fourth touch movement time is less than a reference time information to display a fourth screen menu on the display panel as the icon or menu bar images.

According to one or more embodiments of the present disclosure, a portable display device includes: a display panel including a plurality of planar display areas, and at least one folding area; a touch sensor on a front surface of the display panel to sense a user's touch; a touch driver circuit configured to: divide a touch sensing area of the touch sensor into a plurality of planar sensing areas overlapping with the planar display areas, and at least a folding sensing area overlapping with the at least one folding area; and detect a touch position and a touch movement position on the plurality of planar sensing areas and the at least one folding sensing area to generate at least one touch coordinate data; and a display driver circuit configured to analyze a touch position, a touch movement direction, and a touch movement time on the plurality of planar sensing areas and the at least one folding sensing area to display icon or menu bar images on the display panel to enable a user to control a screen control function and an operation control function of the display panel. The touch driver circuit is configured to: divide a plurality of divided sensing areas that is adjacent to the folding sensing area into sizes for each of the plurality of planar sensing areas; and distinguish the plurality of planar sensing areas from the folding sensing area for each of the plurality of planar sensing areas to detect the touch position.

In an embodiment, the display driver circuit may be configured to: analyze the at least one touch coordinate data to detect one touch or a number of multiple touches occurring concurrently with each other; analyze a touch position in the divided sensing area of each of the plurality of planar sensing areas for each one touch or the number of multiple touches, a touch movement position, and a touch movement time between adjacent divided sensing areas; and display the icon or menu bar images on the display panel according to an analysis result of the touch movement position and the touch movement time between the adjacent divided sensing areas.

In an embodiment, the display driver circuit may be configured to: check the at least one touch coordinate data received from the touch driver circuit; and when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

In an embodiment, the display driver circuit may be configured to: check the at least one touch coordinate data received from the touch driver circuit; and when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

In an embodiment, the display driver circuit may be configured to: analyze the at least one touch coordinate data to detect one touch or a number of multiple touches occurring concurrently with each other; analyze a touch position in the plurality of planar sensing areas and the divided sensing area of each of the plurality of planar sensing areas for each of the one touch or the number of multiple touches, a touch movement position, and a touch movement time between adjacent divided sensing areas; and display the icon or menu bar images on the display panel according to an analysis result of the touch movement position and the touch movement time between the adjacent divided sensing areas.

According to some embodiments of the present disclosure, interface functionality and user convenience of a portable display device may be improved by displaying icons or menu bars that allow a user to select or control built-in features according to the position of the user's touch/drawing operations.

According to some embodiments of the present disclosure, user satisfaction and reliability of a portable display device may be improved by supporting users to control certain built-in features with only one-touch movement by sensing touch/drawing operations in a folding area and adjacent areas in a foldable display device.

However, the present disclosure is not limited to the above aspects and features, and the above and other aspects and features of the present disclosure will be set forth, in part, in the detailed description that follows with reference to the drawings, and in part, may be apparent from therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative embodiments with reference to the accompanying drawings, in which:

FIG. 1 is a perspective view showing a portable display device that is foldable according to an embodiment of the present disclosure;

FIG. 2 is a plan view showing a configuration of a portable display device according to an embodiment of the present disclosure;

FIG. 3 is a cross-sectional view showing one side of the portable display device shown in FIG. 2 in more detail;

FIG. 4 is a view showing a layout of a display panel according to an embodiment of the present disclosure;

FIG. 5 is a view showing a layout of a touch sensing unit according to an embodiment of the present disclosure;

FIG. 6 is a block diagram according to a first embodiment illustrating a folding area, a plurality of planar sensing areas, and a plurality of divided sensing areas that are distinguished from one another in the touch sensing area of FIG. 5;

FIG. 7 is an enlarged view showing the first divided sensing area, the folding area, and the second divided sensing area where a user's touch is sensed;

FIG. 8 is a flowchart illustrating a touch sensing process by the touch sensing unit and the touch driver circuit, and a screen menu display process by the display driver circuit;

FIG. 9 is a block diagram according to a second embodiment illustrating a folding area, a plurality of planar sensing areas, and a plurality of divided sensing areas that are distinguished from one another in the touch sensing area of FIG. 5;

FIG. 10 is a view showing an image of a display screen where an icon and a menu bar are displayed according to one-point and two-point movement sensing;

FIG. 11 is a block diagram according to a third embodiment illustrating a folding area, a plurality of planar sensing areas, and a plurality of divided sensing areas that are distinguished from one another in the touch sensing area of FIG. 5;

FIG. 12 is an enlarged view showing the first planar sensing area, the first divided sensing area, the folding area, the second divided sensing area, and the second planar sensing area where a user's touch is sensed;

FIG. 13 is a flowchart illustrating a touch sensing process by the touch sensing unit and the touch driver circuit, and a screen menu display process by the display driver circuit;

FIG. 14 is a block diagram according to a fourth embodiment illustrating a folding area, a plurality of planar sensing areas, and a plurality of divided sensing areas that are distinguished from one another in the touch sensing area of FIG. 5;

FIG. 15 is a view showing an image of a display screen where icons are displayed according to one-point and two-point movement sensing;

FIG. 16 is a perspective view showing a display device according to another embodiment of the present disclosure;

FIG. 17 is a perspective view showing the display device shown in FIG. 16 when folded;

FIG. 18 is a perspective view showing a display device according to another embodiment of the present disclosure; and

FIG. 19 is a perspective view showing the display device shown in FIG. 18 in a multi-folding state.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

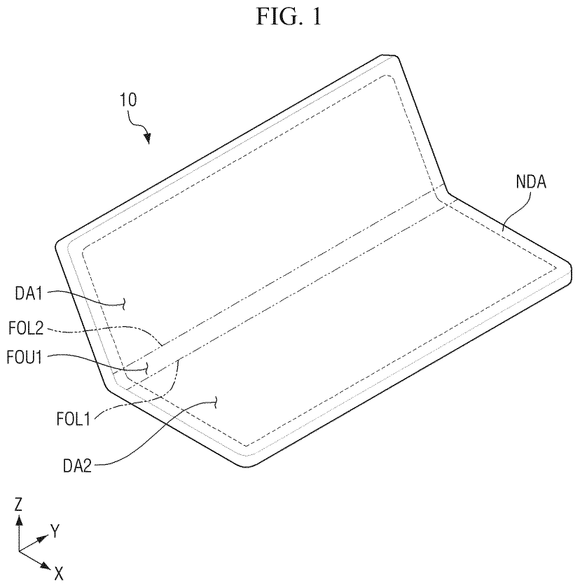

FIG. 1 is a perspective view showing a portable display device that is foldable according to an embodiment of the present disclosure.

Referring to FIG. 1, a portable display device according to an embodiment of the present disclosure (also referred to as a display device 10) may be employed by various suitable portable electronic devices, such as a mobile phone, a smart phone, a tablet PC, a mobile communications terminal, an electronic notebook, an electronic book, a portable multimedia player (PMP), a navigation device, and a ultra mobile PC (UMPC), as a foldable display device. As another example, the display device 10 according to an embodiment of the present disclosure may be used as a display unit (e.g., a display or a display screen) of a television, a laptop computer, a monitor, an electronic billboard, or an Internet of Things (IOT) device.

As used herein, a first direction (e.g., the x-axis direction) may be the shorter side direction of the display device 10 when it is folded, for example, such as the horizontal direction of the display device 10. A second direction (e.g., the y-axis direction) may be the longer side direction of the display device 10 when it is folded, for example, such as the vertical direction of the display device 10. A third direction (e.g., the z-axis direction) may refer to the thickness direction of the display device 10.

In the example shown in FIG. 1, the display device 10 is a foldable display device that may be folded once in the first direction (e.g., the x-axis direction). The display device 10 may be transformed into between a folding state in which it is folded once, a flexed state in which it is bent at an angle (e.g., a predetermined angle), and a flat state in which it is fully unfolded, and/or may be held in one of the states.

The display device 10 may be folded inward, such that the front surface where images are displayed is located inside (e.g., an in-folding manner). When the display device 10 is bent or folded in the in-folding manner, a part of the front surface of the display device 10 may face another part of the front surface. As another example, the display device 10 may be folded outward, such that the front surface where the images are displayed is located outside (e.g., an out-folding manner). When the display device 10 is bent or folded in the out-folding manner, a part of the rear surface of the display device 10 may face another part of the rear surface.

An image display area of the display device 10 may be divided into a plurality of non-folding areas DA1 and DA2, and a first folding area FOU1. For example, the first folding area FOU1 may be located between the first and second non-folding areas DA1 and DA2. A non-display area NDA may be formed at the border of the entire image display area (e.g., the borders of the plurality of non-folding areas DA1 and DA2 and the first folding area FOU1).

The first folding area FOU1 may be located between the first and second non-folding areas DA1 and DA2, and may extend in the second direction (e.g., the y-axis direction). The first folding area FOU1 may be folded inward or outward in the first direction DR1 (e.g., the x-axis direction). In other words, the first non-folding area DA1 may be located on one side, for example, such as on the right side, of the first folding area FOU1. The second non-folding area DA2 may be located on the opposite side, for example, such as on the left side, of the first folding area FOU1. The first folding area FOU1 and first and second folding lines FOL1 and FOL2 may extend in the second direction (e.g., the y-axis direction), and the display device 10 may be folded in the first direction (e.g., the x-axis direction).

When the first folding area FOU1 is folded inward, the front surfaces of the first and second non-folding areas DA1 and DA2 may face each other. As such, when the first folding area FOU1 extends in the second direction (e.g., the y-axis direction) and is folded inward or outward in the first direction (e.g., the x-axis direction), the width of the display device 10 in the first direction (e.g., the x-axis direction) may be reduced to approximately half.

When the first folding area FOU1 and the first and second folding lines FOL1 and FOL2 are disposed along the first direction (e.g., the x-axis direction) so that they extend in the second direction (e.g., the y-axis direction), the width of the first folding area FOU1 in the first direction (e.g., the x-axis direction) may be smaller or narrower than the length in the second direction (e.g., the y-axis direction). In addition, the width of the first non-folding area DA1 in the first direction (e.g., the x-axis direction) may be larger than the width of the first folding area FOU1 in the first direction (e.g., the x-axis direction). The width of the second non-folding area DA2 in the first direction (e.g., the x-axis direction) may also be formed to be larger than the width of the first folding area FOU1 in the first direction (e.g., the x-axis direction).

The image display area of the display device 10 on the front side may overlap with the first non-folding area DA1, the first folding area FOU1, and the second non-folding area DA2. Therefore, when the display device 10 is unfolded as shown in FIG. 1, images may be displayed on the front side in the folding area FDA, the first non-folding area NFA1, and the second non-folding area NFA2 of the display device 10.

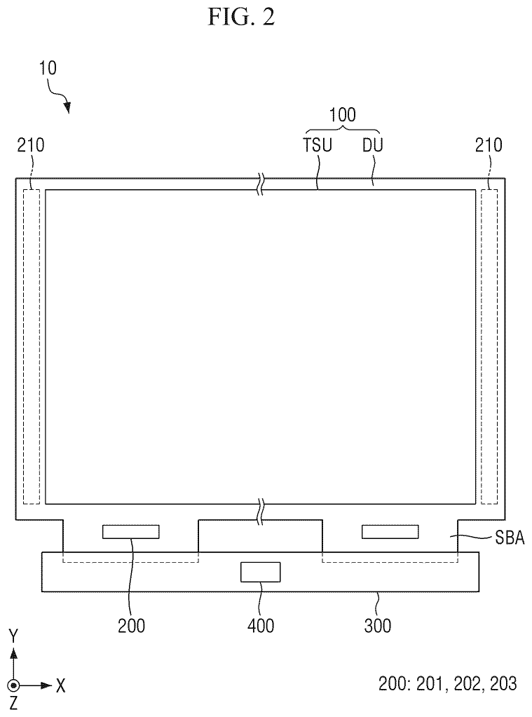

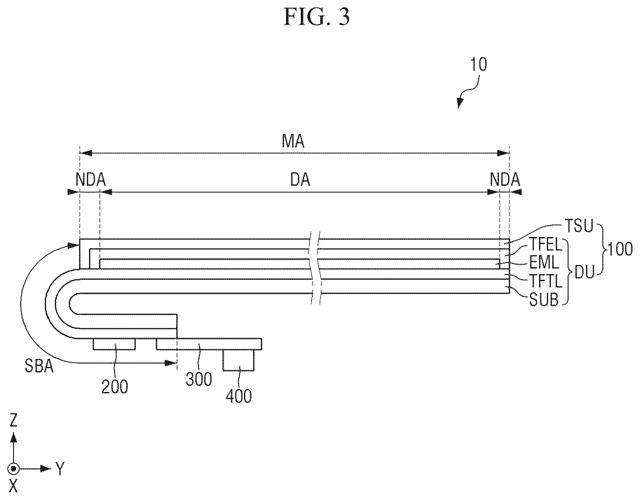

FIG. 2 is a plan view showing a configuration of a portable display device according to an embodiment of the present disclosure. FIG. 3 is a cross-sectional view showing one side of the portable display device shown in FIG. 2 in more detail.

Referring to FIGS. 2 and 3, a display device 10 according to the present embodiment may be sorted into a variety of suitable devices depending on the way in which the images are displayed. For example, the display device 10 may be classified into, and implemented as, an organic light-emitting display device (OLED), an inorganic light-emitting display device (inorganic EL), a quantum-dot light-emitting display device (QED), a micro LED display device (micro-LED), a nano LED display device (nano-LED), a plasma display device (PDP), a field emission display device (FED), a liquid-crystal display device (LCD), an electrophoretic display device (EPD), and the like. Hereinafter, an organic light-emitting display device (OLED) will be described in more detail as a representative example of the display device 10. The organic light-emitting display device OLED may be simply referred to as the display device 10, unless it is necessary to distinguish between them. However, the present disclosure is not limited to the organic light-emitting display device (OLED), and one of the above-described display devices, or any other suitable display device known to those having ordinary skill in the art, may be employed as the display device 10.

As shown in FIGS. 2 and 3, the display device 10 includes a touch sensing module (e.g., a touch sensor). The touch sensing module includes a touch sensing unit (e.g., a touch sensing layer or a touch sensing panel) TSU disposed on the front surface of the display panel 100, and at least one touch driver circuit 400 for generating touch coordinate data of the touch sensing unit TSU.

In more detail, the display panel 100 of the display device 10 may include a display unit (e.g., a display or a display layer) DU for displaying images, and the touch sensing unit TSU is disposed on the display unit DU of the display panel 100 to sense a touch by a touch input device, such as a part of a human body (e.g., a finger) and/or an electronic pen.

The display unit DU of the display panel 100 may include a plurality of pixels. Images may be displayed through the plurality of pixels. Each pixel may include red, green, and blue sub-pixels, or red, green, blue, and white sub-pixels.

The touch sensing unit TSU may be mounted on the front side of the display panel 100, or may formed integrally with the display panel 100 on the front surface of the display panel 100. The touch sensing unit TSU may include a plurality of touch electrodes to sense a user's touch by capacitive sensing using the touch electrodes. The touch sensing unit TSU may be mounted on the display unit DU of the display panel 100, or may be formed integrally with the display unit DU.

The touch driver circuit 400 may be implemented as at least one microprocessor that is electrically connected to the touch sensing unit TSU (e.g., to touch sensing areas). The touch driver circuit 400 may supply touch driving signals to the plurality of touch electrodes arranged in a matrix in the touch sensing unit TSU, and may sense a change in a capacitance between the plurality of touch electrodes. The touch driver circuit 400 may determine whether or not a user's touch is input, and may produce the touch coordinate data based on an amount of a change in the capacitance between the touch electrodes. The elements and structural features of the touch driver circuit 400 and the touch sensing unit TSU will be described in more detail below.

The display driver circuit 200 may output control signals and data voltages to drive the pixels of the display unit DU (e.g., sub-pixels that are divided into red, green, blue, white, and/or the like sub-pixels). The display driver circuit 200 may supply data voltages to data lines connected to the sub-pixels. The display driver circuit 200 may apply a supply voltage to a voltage line, and may supply gate control signals to at least one gate driver 210. The display driver circuit 200 may be divided into a timing controller for performing a timing control function, and a data driver for supplying data voltages to the data lines. In this case, the display driver circuit 200 may supply at least one timing control signal to the gate driver 210 and the data driver to control driving timings of the gate driver 210 and the data driver.

The display driver circuit 200 may control the overall functions of the display device 10. For example, the display driver circuit 200 may receive touch coordinate data on the touch sensing unit TSU from the touch driver circuit 400 to determine the user's touch coordinates, and may generate digital video data based on the touch coordinates. In addition, the display driver circuit 200 may run an application indicated by an icon displayed on the user's touch coordinates. As another example, the display driver circuit 200 may receive coordinate data from an electronic pen to determine the touch coordinates of the electronic pen, and may generate digital video data according to the touch coordinates, or may run an application indicated by an icon displayed at the touch coordinates of the electronic pen.

Referring to FIG. 3, the display panel 100 may be divided into a main area MA and a subsidiary area SBA. The main area MA may include a display area DA where the sub-pixels for displaying images are disposed, and a non-display area NDA located around the display area DA. In the display area DA, light may be emitted from an emission area or an opening area of each corresponding sub-pixel to display an image. As such, each of the sub-pixels arranged in the display device DA may include a pixel circuit including switching elements, a pixel-defining layer that defines the emission area or the opening area, and a self-light-emitting element.

The non-display area NDA may be the peripheral area (e.g., the outer area) of the display area DA. The non-display area NDA may be defined as an edge of the main area MA that corresponds to the display area DA of the display panel 100. The non-display area NDA may include at least one gate driver 210 that supplies gate signals to the gate lines, and fan-out lines that connect the display driver circuit 200 with the display area DA.

The subsidiary area SBA may extend from one side of the main area MA. The subsidiary area SUB may include a flexible material that may be bent, folded, or rolled. For example, when the subsidiary area SBA is bent, the subsidiary area SBA may overlap with the main area MA in the thickness direction (e.g., the z-axis direction). The subsidiary area SBA may include pads connected to the display driver circuit 200 and the circuit board 300. However, the present disclosure is not limited thereto, and the subsidiary area SBA may be omitted as needed or desired, and the display driver circuit 200 and the pads may be disposed in the non-display area NDA.

The circuit board 300 may be attached on the pad area of the display panel 100 using an anisotropic conductive film (ACF). Lead lines of the circuit board 300 may be electrically connected to the pads of the display panel 300. The circuit board 300 may be a flexible printed circuit board (FPCB), a printed circuit board (PCB), or a flexible film such as a chip-on-film (COF).

The substrate SUB of the display panel 100 shown in FIG. 3 may be a base substrate or a base member. The substrate SUB may be of a flat or substantially flat type. As another example, the substrate SUB may be a flexible substrate that may be bent, folded, or rolled. For example, the substrate SUB may include, but is not limited to, a glass material or a metal material. As another example, the substrate SUB may include a polymer resin such as polyimide PI.

The thin-film transistor layer TFTL may be disposed on the substrate SUB. The thin-film transistor layer TFTL may include a plurality of thin-film transistors for forming the pixel circuits of the sub-pixels. The thin-film transistor layer TFTL may include the gate lines, the data lines, the voltage lines, gate control lines, the fan-out lines for connecting the display driver circuit 200 with the data lines, lead lines for connecting the display driver circuit 200 with the pads, and/or the like. When the gate driver 210 (e.g., a plurality of gate drivers 210) is formed on one side and the opposite side of the non-display area NDA of the display panel 100, each gate driver 210 may also include thin-film transistors.

The thin-film transistor layer TFTL may be selectively disposed in the display area DA, the non-display area NDA, and the subsidiary area SBA. The thin-film transistors in each of the pixels, the gate lines, the data lines, and the voltage lines in the thin-film transistor layer TFTL may be disposed in the display area DA. The gate control lines and the fan-out lines in the thin-film transistor layer TFTL may be disposed in the non-display area NDA. The lead lines of the thin-film transistor layer TFTL may be disposed in the subsidiary area SBA.

The emission material layer EML may be disposed on the thin-film transistor layer TFTL. The emission material layer EML may include a plurality of light-emitting elements, each of which including a first electrode, an emissive layer, and a second electrode that are stacked on one another sequentially to emit light, and a pixel-defining film for defining each of the sub-pixels. The light-emitting elements of the emission material layer EML may be disposed in the display area DA.

An encapsulation layer TFEL may cover the upper and side surfaces of the emission material layer EML, and may protect the emission material layer EML. The encapsulation layer TFEL may include at least one inorganic layer and at least one organic layer for encapsulating the emission material layer EML.

The touch sensing unit TSU including the touch sensing areas may be disposed on the encapsulation layer TFEL of the display panel 100. The touch sensing areas of the touch sensing unit TSU may include a plurality of touch electrodes for sensing a user's touch by capacitive sensing, and touch driving lines connecting the plurality of touch electrodes with at least one touch driver circuit 400. In each of the touch sensing areas, the touch electrodes may be arranged in a matrix to sense a user's touch by self-capacitance sensing or mutual capacitance sensing.

The touch sensing unit TSU may not be formed integrally with the display panel 100, and may be disposed on a separate substrate or film disposed on the display unit DU of the display panel 100. In this case, the substrate of the film supporting the touch sensing unit TSU may be a base member encapsulating the display unit DU. Hereinafter, a representative example in which the touch sensing unit TSU is formed integrally with the front surface of the display unit DU will be described in more detail.

The touch electrodes may be disposed in the touch sensing areas overlapping with the display area DA. On the other hand, touch lines for transmitting touch driving signals or touch sensing signals may be arranged in a touch peripheral area overlapping with the non-display area NDA.

The touch driver circuit 400 that generates touch coordinate data on the touch sensing areas may be disposed in the non-display area NDA or the subsidiary area SBA of the display panel 100. As another example, the touch driver circuit 400 that generates the touch coordinate data may be mounted on a separate circuit board 300. The touch driver circuit 400 may be implemented as an integrated circuit (IC).

The touch driver circuit 400 supplies the touch driving signals to the touch electrodes of the touch sensing areas overlapping with the display area DA, and measures an amount of a change of charges in a mutual capacitance of each of a plurality of touch nodes formed by the touch electrodes. The touch driver circuit 400 measures a change in a capacitance of the touch nodes according to a change in an amount of a voltage or a current of a touch sensing signal received through the touch electrodes. As such, the touch driver circuit 400 may determine a location of the user's touch based on the amount of the change in the mutual capacitance of each of the touch nodes. The touch driving signal may be a pulse signal having a suitable frequency (e.g., a predetermined frequency). The touch driver circuit 400 may determine whether or not there is a touch by a touch input or a part of a user's body such as a finger, and may find the coordinates of the touch, if any, for each of the touch sensing areas based on the amount of the change in the capacitance between the touch electrodes for each of the touch sensing areas.

The touch driver circuit 400 distinguishes in advance a plurality of planar sensing areas overlapping with a plurality of display areas DA from at least one folding sensing area (e.g., the first folding area FOU1). In addition, the touch driver circuit 400 divides each of the planar sensing areas to define a divided sensing area in a suitable size (e.g., a predetermined size) that is adjacent to the folding sensing area (e.g., the first folding area FOU1). Each divided sensing area may be adjacent to the folding sensing area, and may be set in advance in a size or area (e.g., ½, ⅓, ¼, . . . , 1/n) of the respective planar sensing area and may be distinguished therefrom. Accordingly, the touch driver circuit 400 may divide a touch sensing area of the touch sensing unit TSU into a plurality of planar sensing areas, at least one folding sensing area, and a plurality of divided sensing areas to generate and output the touch coordinate data on one touch or multiple touches occurring concurrently or simultaneously with each other.

The touch driver circuit 400 may use the coordinates of touch nodes formed and arranged in a matrix in the touch sensing area to divide and distinguish in advance the touch sensing area into a plurality of planar sensing areas, a plurality of divided sensing areas, and at least one folding sensing area. In generating the touch coordinate data as a touch occurs and is sensed, the touch driver circuit 400 may compare the coordinates of the touch nodes with the touch coordinates of the touch coordinate data to determine the position of the touch in each of the plurality of planar sensing areas, the plurality of divided sensing areas, and at least one folding sensing area. The touch driver circuit 400 may transmit the touch coordinate data to the display driver circuit 200 along with area codes for the plurality of planar sensing areas, the plurality of divided sensing areas, and at least one folding sensing area, respectively.

The display driver circuit 200 detects the number of one-touch or multiple touches that occur concurrently or substantially simultaneously with each other through the touch coordinate data from the touch driver circuit 400, and analyzes the touch movement position of the one touch or the multiple touches on each of the divided sensing areas and touch movement time between the plurality of divided sensing areas. Based on the results of the analysis, at least one user interface icon or menu bar (e.g., an icon, a menu bar, and/or the like) may be displayed on the screen of the display panel 100, so that the user can select or control the built-in features of the display device 10.

In addition, the display driver circuit 200 may analyze the touch movement position of the one touch or the multiple touches on each of the plurality of planar sensing areas and the plurality of divided sensing areas, and the touch movement time between the plurality of divided sensing areas. Based on the analysis results, icons, menu bars, and/or the like may be displayed on the screen of the display panel 100, so that the user can select or control the built-in features of the display device 10. Interface performance according to the movement position and drawing analysis on one touch or multiple touches of the display driving circuit 200 will be described in more detail below.

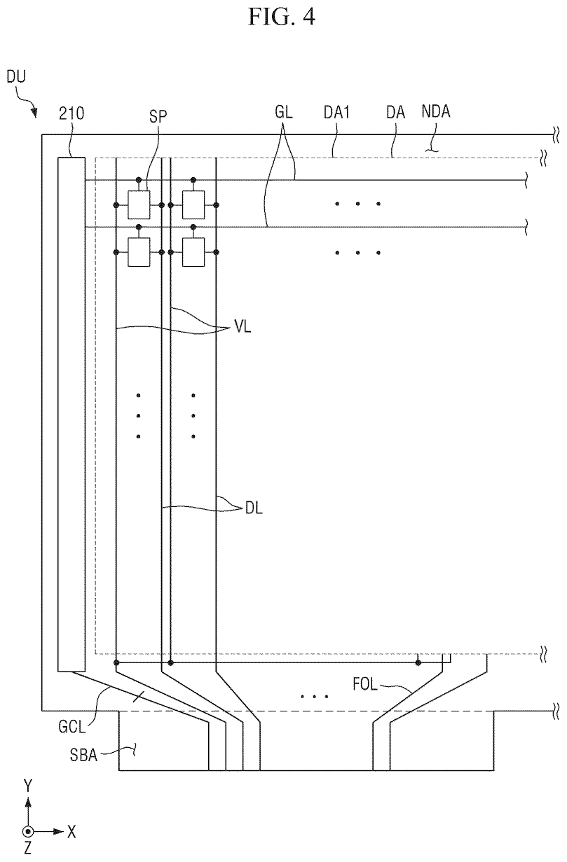

FIG. 4 is a view showing a layout of a display panel according to an embodiment of the present disclosure. In more detail, FIG. 4 is a view showing a layout of a part of the display area DA and the non-display area NDA of the display unit DU before the touch sensing unit TSU is formed.

The display area DA displays images therein, and may be defined as a central area of the display panel 100. For example, the display area DA may include a plurality of sub-pixels SP, a plurality of gate lines GL, a plurality of data lines DL, a plurality of voltage lines VL, and the like. Each of the plurality of sub-pixels SP may be defined as a minimum unit that outputs red light, green light, blue light, white light, or the like.

The plurality of gate lines GL may supply the gate signals received from at least one gate driver 210 to the plurality of sub-pixels SP. The plurality of gate lines GL may extend in the x-axis direction, and may be spaced apart from one another in the y-axis direction crossing the x-axis direction.

The plurality of data lines DL may supply the data voltages received from the display driver circuit 200 to the plurality of sub-pixels SP. The plurality of data lines DL may extend in the y-axis direction, and may be spaced apart from one another in the x-axis direction.

The plurality of voltage lines VL may apply a supply voltage received from the display driver circuit 200 or a separate power supply unit (e.g., a separate power supply) to the plurality of pixels SP. The supply voltage may be at least one of a driving voltage, an initialization voltage, and/or a reference voltage. The plurality of voltage lines VL may extend in the y-axis direction, and may be spaced apart from one another in the x-axis direction.

The non-display area NDA is a peripheral area surrounding (e.g., around a periphery of) the display area DA where images are displayed, and may be defined as a bezel area. The non-display area NDA may include the gate driver 210, fan-out lines FOL, and gate control lines GCL. The gate driver 210 may generate a plurality of gate signals based on the gate control signal, and may sequentially supply the plurality of gate signals to the plurality of gate lines GL in a suitable order (e.g., a predetermined order).

The fan-out lines FOL may extend from the display driver circuit 200 to the display area DA. The fan-out lines FOL may supply the data voltage received from the display driver circuit 200 to the plurality of data lines DL.

The gate control lines GCL may extend from the display driver circuit 200 to the gate driver 210. The gate control lines GCL may supply the gate control signal received from the display driver circuit 200 to the gate driver 210.

The display driver circuit 200 may output signals and voltages for driving the display panel 100 to the fan-out lines FOL. The display driver circuit 200 may provide data voltages to the data lines DL through the fan-out lines FOL. The data voltages may be applied to the plurality of sub-pixels SP, so that a luminance of the plurality of sub-pixels SP may be determined. The display driver circuit 200 may supply a gate control signal to the gate driver 210 through the gate control lines GCL.

The display driver circuit 200 may divide the plurality of planar sensing areas overlapping with the respective planar display areas DA, at least one folding sensing area (e.g., the first folding area FOU1), and the plurality of divided sensing areas of the planar sensing areas adjacent to the folding sensing area into suitable sizes (e.g., predetermined sizes), and may distinguish them from one another. As such, the coordinates of the touch nodes arranged in a matrix in the touch sensing area may be used, so that the plurality of planar sensing areas, the at least one folding sensing area, and the plurality of divided sensing areas adjacent to the folding sensing area may be divided in advance and distinguished from one another.

The display driver circuit 200 compares the touch coordinates of the touch coordinate data input from the touch driver circuit 400 with the coordinates of the touch nodes when a touch occurs. Then, the display driver circuit 200 detects the number of one-touch or multiple touches that occur concurrently or substantially simultaneously with each other based on the comparison results, and analyzes the touch movement position of the one touch or the multiple touches on each of the divided sensing areas and the touch movement time between the divided sensing areas.

The display driver circuit 200 may generate digital video data for controlling built-in features (e.g., predetermined built-in features) to correspond to the touch movement position of the one touch or the multiple touches on each of the divided sensing areas and the touch movement time between the divided sensing areas. For example, the display driver circuit 200 may create digital video data, such as icons or menu bars, so that users can check and control screen control functions, such as brightness, chromaticity, resolution, and contrast, and operation control functions, such as volume, power, and mute, according to the number of touch movements, the touch movement position, and the touch movement direction between the divided sensing areas. In addition, the display driver circuit 200 may control the built-in features, such as screen control functions and operation control functions, and may run application programs according to the user's touch actions that are determined and recognized in real time through the touch coordinate data.

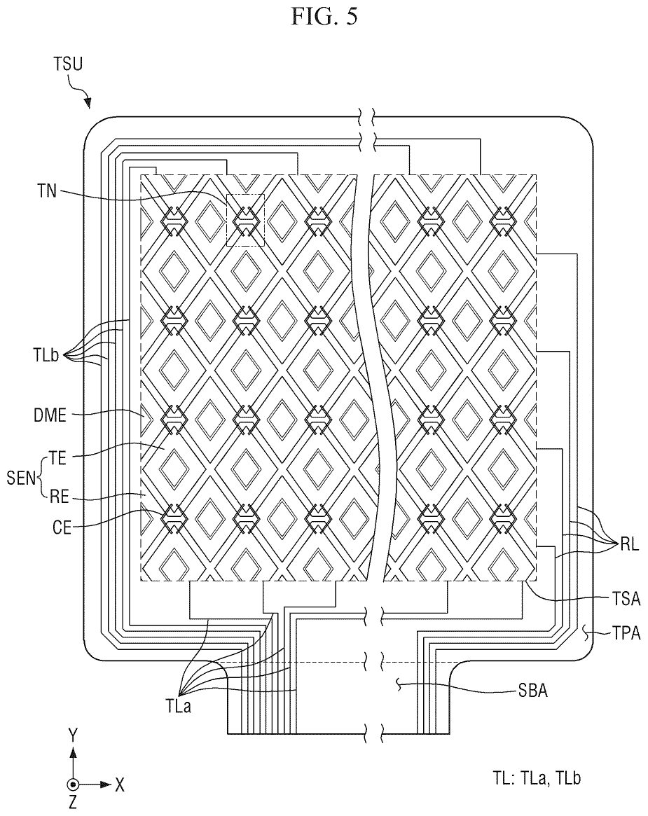

FIG. 5 is a view showing a layout of a touch sensing unit according to an embodiment of the present disclosure. In more detail, FIG. 5 is a view showing a layout of a structure of the touch sensing area TSA corresponding to the display area DA when viewed from the top (e.g., in a plan view).

Referring to FIG. 5, the touch sensing unit TSU may include a touch sensing area TSA that senses a user's touch, and a touch peripheral area TPA around the touch sensing area TSA.

The touch sensing area TSA may cover the display area DA and the non-display area NDA of the display unit DU, and may overlap with the display area DA and the non-display area NDA. Because the non-display area NDA is the bezel area, the outer areas of the touch sensing area TSA that overlap with and is in line with the non-display area NDA correspond to the bezel area.

The touch peripheral area TPA corresponds to the area in which the gate driver 210 is disposed. Accordingly, the touch sensing area TSA is extended, overlapped with, and disposed on the non-display area NDA except for the area in which the gate driver 210 is disposed.

The touch sensing area TSA may include a plurality of touch electrodes SEN and a plurality of dummy electrodes DME. The plurality of touch electrodes SEN may form a mutual capacitance or a self capacitance to sense a touch of an object or person. The plurality of touch electrodes SEN may include a plurality of driving electrodes TE and a plurality of sensing electrodes RE.

The plurality of driving electrodes TE may be arranged along the x-axis direction and the y-axis direction. The plurality of driving electrodes TE may be spaced apart from one another in the x-axis direction and the y-axis direction. The driving electrodes TE that are adjacent to each other in the y-axis direction may be electrically connected to each other through a plurality of connection electrodes CE.

The plurality of driving electrodes TE may be connected to first touch pads through driving lines TL. The driving lines TL may include lower driving lines TLa and upper driving lines TLb. For example, some of the driving electrodes TE disposed on the lower side of the touch sensing area TSA may be connected to the first touch pads through the lower driving lines TLa, and some others of the driving electrodes TE disposed on the upper side of the touch sensing area TSA may be connected to the first touch pads through the upper driving lines TLb. The lower driving lines TLa may extend to the first touch pads beyond the lower side of the touch peripheral area TPA. The upper driving lines TLb may extend to the first touch pads along the upper side, the left side, and the lower side of the touch peripheral area TPA. The touch pads may be formed on the circuit board 300 or the like, and may be connected to at least one touch driver circuit 400.

The driving electrodes TE that are adjacent to one another in the y-axis direction may be electrically connected to each other by the plurality of connection electrodes CE. Even if one of the connection electrodes CE is disconnected, the driving electrodes TE may be stably connected to each other through the other remaining connection electrodes CE. The driving electrodes TE that are adjacent to each other may be connected to each other by two connection electrodes CE, but the number of connection electrodes CE is not limited thereto. The connection electrodes CE may be bent at least once. Although the connection electrodes CE may have a shape of an angle bracket “<” or “>”, the shape of the connection electrodes CE when viewed from the top (e.g., in a plan view) is not limited thereto.

The connection electrodes CE may be disposed at (e.g., in or on) a different layer from those of the plurality of driving electrodes TE and the plurality of sensing electrodes RE. The driving electrodes TE that are adjacent to one another in the y-axis direction may be electrically connected to each other through the connection electrodes CE that are disposed at (e.g., in or on) a different layer from those of the plurality of driving electrodes TE or the plurality of sensing electrodes RE. The connection electrodes CE may be formed on the rear layer (e.g., the lower layer) of the layer at (e.g., in or on) which the driving electrodes TE and the sensing electrodes RE are formed. The connection electrodes CE are electrically connected to the driving electrode TE through a plurality of contact holes. Accordingly, even though the connection electrodes CE overlap with the plurality of sensing electrodes RE in the z-axis direction, the plurality of driving electrodes TE and the plurality of sensing electrodes RE may be insulated from each other. Mutual capacitances may be formed between the driving electrodes TE and the sensing electrodes RE.

The sensing electrodes RE that are adjacent to one another in the x-axis direction may be electrically connected to one another through connection portions disposed at (e.g., in or on) the same layer as those of the plurality of driving electrodes TE or the plurality of sensing electrodes RE. In other words, the plurality of sensing electrodes RE may extend in the x-axis direction, and may be spaced apart from one another in the y-axis direction. The plurality of sensing electrodes RE may be arranged along the x-axis direction and the y-axis direction, and the sensing electrodes RE that are adjacent to one another in the x-axis direction may be electrically connected to each other through the connection portions.

Touch nodes TN may be formed at crossings or intersections of the connection electrodes CE connecting between the driving electrodes TE and the connection portions of the sensing electrodes RE. The touch nodes TN may be arranged in a matrix in the touch sensing area TSA.

The plurality of sensing electrodes RE may be connected to second touch pads through sensing lines RL. For example, some of the sensing electrodes RE disposed on the right side of the touch sensing area TSA may be connected to the second touch pads through the sensing lines RL. The sensing lines RL may extend to the second touch pads along the right side and the lower side of the touch peripheral area TPA. The second touch pads may be connected to at least one touch driver circuit 400 through the circuit board 300.

Each of the plurality of dummy electrodes DME may be surrounded (e.g., around a periphery thereof) by a corresponding driving electrode TE or a corresponding sensing electrode RE. Each of the plurality of dummy electrodes DME may be spaced apart from and insulated from the corresponding driving electrode TE or the corresponding sensing electrode RE. Accordingly, the dummy electrodes DME may be electrically floating.

The touch driver circuit 400 supplies the touch driving signals to the driving electrodes TE. The touch driver circuit 400 receives the signals fed back from each of the driving electrodes TE as the touch sensing signals of the driving electrodes TE, and receives touch sensing signals on the sensing electrodes RE from each of the sensing electrodes RE. Accordingly, the touch driver circuit 400 measures a change in a magnitude of the touch sensing signals received from the driving electrodes TE and the sensing electrodes RE, and measures an amount of charge in a mutual capacitance of each of the touch nodes TN formed by the driving electrodes TE and the sensing electrodes RE. The touch driver circuit 400 may determine a position of the user's touch and the touch movement direction based on the amount of change in the mutual capacitance of each of the touch nodes. As described above, the touch driver circuit 400 may determine whether or not there is a touch by a touch input or a part of a user's body such as a finger, and may determine the coordinates of the touch, if any, for each of the touch sensing areas based on the amount of the change in the capacitance between the touch electrodes.

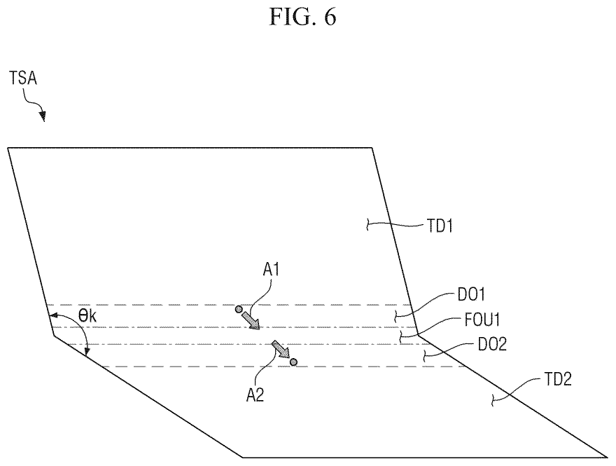

FIG. 6 is a block diagram according to a first embodiment illustrating a folding area, a plurality of planar sensing areas, and a plurality of divided sensing areas that are distinguished from one another in the touch sensing area of FIG. 5.

Referring to FIG. 6, the touch sensing area TSA of the touch sensing unit TSU may be transformed into a flexed state in which it is bent at an angle (e.g., a predetermined angle) Ok together with the display unit DU of the display panel 100, a flat state in which it is completely unfolded, or a folding state in which it is folded once. The touch sensing area TSA of the touch sensing unit TSU detects the number and the touch position of one touch or multiple touches occurring concurrently or substantially simultaneously with each other even in the flexed state in which it is bent at the angle (e.g., the predetermined angle) Ok, and senses drawing operations such as a touch movement position of the one touch or the multiple touches.

The touch driver circuit 400 divides and distinguishes the plurality of planar sensing areas TD1 and TD2 overlapping with the planar display areas DA, respectively, from at least one folding sensing area (e.g., the first folding area FOU1).

In addition, the touch driver circuit 400 divides each of the divided sensing areas DO1 and DO2 of the planar sensing areas TD1 and TD2, which is adjacent to at least one folding sensing area (e.g., the first folding region FOU1), into a suitable size (e.g., a predetermined size) and distinguishes them. For example, the touch driver circuit 400 may divide and distinguish the first divided sensing area DO1 that is adjacent to the first folding area FOU1 from the first planar sensing area TD1, and may divide and distinguish the second divided sensing area DO2 that is adjacent to the first folding area FOU1 from the second planar sensing area TD2. Each of the divided sensing areas DO1 and DO2 may be determined (e.g., may be set) in advance and divided into the size or the area of ½, ⅓, ¼, . . . , 1/n, or the like of the corresponding planar sensing area TD1 or TD2, where n is a positive integer. The touch driver circuit 400 may transmit to the display driver circuit 200 the touch coordinate data of the one touch or the multiple touches that are generated concurrently or substantially simultaneously with each other, along with area codes for the planar sensing areas TD1 and TD2, the at least one folding area FOU1, and the plurality of divided sensing areas DO1 and DO2.

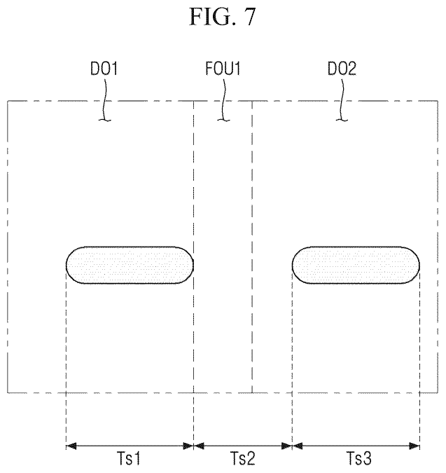

FIG. 7 is an enlarged view showing the first divided sensing area, the folding area, and the second divided sensing area where a user's touch is sensed.

Referring to FIGS. 6 and 7, a user may first touch the first divided sensing area DO1 of the first planar sensing area TD1 as shown by an arrow A1, and then may keep touching while moving (e.g., drawing) down to the second divided sensing area DO2 of the second planar sensing area TD2.

In this case, the touch driver circuit 400 may transmit to the display driver circuit 200 the touch coordinate data that sequentially includes a user touch position on the first divided sensing area DO1 of the first planar sensing area TD1, a touch movement position on the first divided sensing area DO1, a user touch position on the second divided sensing area DO2 of the second planar sensing area TD2, and a touch movement position on the second divided sensing area DO2. In addition, the touch driver circuit 400 may transmit to the display driver circuit 200 the area code for each of the first and second divided sensing areas DO1 and DO2 together with the touch coordinate data.

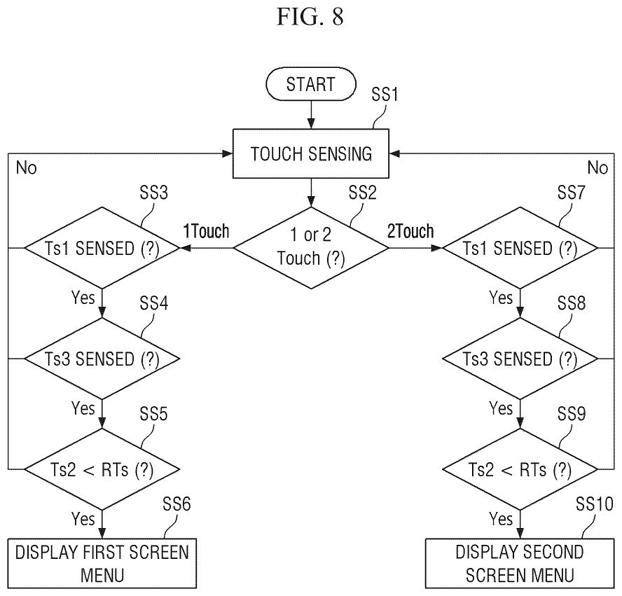

FIG. 8 is a flowchart illustrating a touch sensing process by the touch sensing unit and the touch driver circuit, and a screen menu display process by the display driver circuit.

Referring to FIGS. 7 and 8, the touch driver circuit 400 may supply touch driving signals to the touch electrodes arranged in a matrix in the touch sensing unit TSU, and may sense an amount of change in the capacitance between the touch electrodes to detect a user's touch operation and the touch position in real time (SS1). For example, the touch driver circuit 400 may transmit to the display driver circuit 200 the touch coordinate data sequentially including the user's touch position and the touch movement position, in addition to the area codes for the first and second divided sensing areas DO1 and DO2.

The display driver circuit 200 checks the touch coordinate data received from the touch driver circuit 400 in real time. If the touch position coordinates on the first divided sensing area DO1 of the first planar sensing area TD1 are identified, the display driver circuit 200 checks the number of touch position coordinates that are concurrently or substantially simultaneously input and generated with each other to detect the number of one touch or multiple touches that are generated concurrently or substantially simultaneously with each other (SS2).

When only one touch occurs in the first divided sensing area DO1, the display driver circuit 200 sequentially analyzes the touch coordinates of the first divided sensing area DO1 to detect the touch movement position and a touch movement time Ts1 in the first divided sensing area DO1 (SS3).

To detect the touch movement time Ts1 of the first divided sensing area DO1, the display driver circuit 200 checks whether or not the touch position coordinates of the second divided sensing area DO2 of the second planar sensing area TD2 are detected, and may analyze the touch coordinates of the second divided sensing area DO2 sequentially to detect the touch movement position and a touch movement time Ts3 in the second divided sensing area DO2 (SS4).

To detect the touch movement time Ts3 of the second divided sensing area DO2, the display driver circuit 200 detects a first touch movement time Ts2, which is the time interval between the touch movement time Ts1 in the first divided sensing area DO1 and the touch movement time Ts3 in the second divided sensing area DO2. The display driver circuit 200 compares the first touch movement time Ts2 according to the movement of the touch position between the first divided sensing area DO1 and the second divided sensing area DO2 to a reference time information (e.g., a predetermined reference time information) RTs (SS5).

If the first touch movement time Ts2 is less than the reference time information (e.g., the predetermined reference time information) RTs (e.g., if the first touch movement time Ts2 is faster than the reference time information RTs), the display driver circuit 200 determines that it is the user's first interface command. In this case, a first screen menu including a first icon (e.g., a predetermined first icon) or a first menu bar may be displayed on the screen of the display panel 100, so that the user can select or control the built-in features of the display device 10 (SS6).

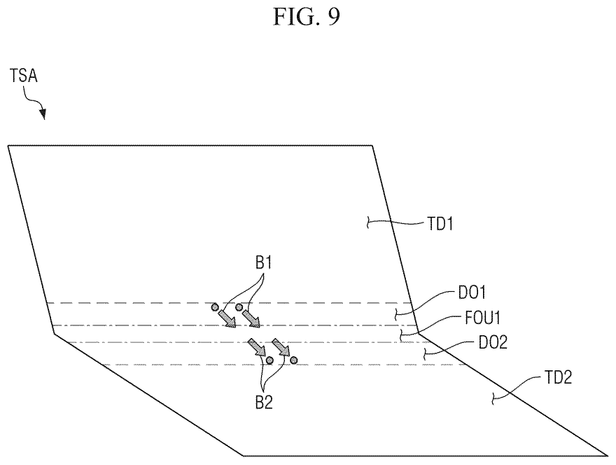

FIG. 9 is a block diagram according to a second embodiment illustrating a folding area, a plurality of planar sensing areas, and a plurality of divided sensing areas that are distinguished from one another in the touch sensing area of FIG. 5.

Referring to FIG. 9, a user may first touch the first divided sensing area DO1 of the first planar sensing area TD1 with fingers as shown by an arrow B1, and then may keep touching while moving (e.g., drawing) down to the second divided sensing area DO2 of the second planar sensing area TD2.

The touch driver circuit 400 may transmit to the display driver circuit 200 the touch coordinate data including the touch coordinates and the touch movement positions, along with the area codes for the first and second divided sensing areas DO1 and DO2.

Referring to FIG. 9 in conjunction with FIG. 8, the display driver circuit 200 checks a plurality of touch coordinate data received from the touch driver circuit 400 in real time, and checks the coordinates of multiple touch positions on the first divided sensing area DO1 of the first planar sensing area TD1. Once the touch position coordinates are identified, the number of touch position coordinates input and generated concurrently or substantially simultaneously with each other is checked to detect the number of one touch or multiple touches that are generated concurrently or substantially simultaneously with each other (SS2).

If multiple touches occur in the first divided sensing area DO1, the display driver circuit 200 sequentially analyzes one touch coordinate data of the first divided sensing area DO1 to detect the touch movement position and the touch movement time Ts1 in the first divided sensing area DO1 (SS7).

To detect the touch movement time Ts1 of the first divided sensing area DO1, the display driver circuit 200 checks whether or not the touch position coordinates of the second divided sensing area DO2 of the second planar sensing area TD2 are detected, and analyzes one touch coordinate data of the second divided sensing area DO2 sequentially to detect the touch movement position and the touch movement time Ts3 in the second divided sensing area DO2 (SS8).

To detect the touch movement time Ts3 of the second divided sensing area DO2, the display driver circuit 200 detects a first touch movement time Ts2, which is the time interval between the touch movement time Ts1 in the first divided sensing area DO1 and the touch movement time Ts3 in the second divided sensing area DO2. The display driver circuit 200 compares the first touch movement time Ts2 according to the movement of the touch position between the first divided sensing area DO1 and the second divided sensing area DO2 to a reference time information (e.g., a predetermined reference time information) RTs (SS9).

When the first touch movement time Ts2 is less than the reference time information (e.g., the predetermined reference time information) RTs (e.g., if the touch movement time Ts2 is faster than the reference time information RTs), the display driver circuit 200 determines that it is the user's second interface command. In this case, a second screen menu including a second icon (e.g., a predetermined second icon) or a second menu bar may be displayed on the screen of the display panel 100, so that the user can select or control the built-in features of the display device 10 (SS10).

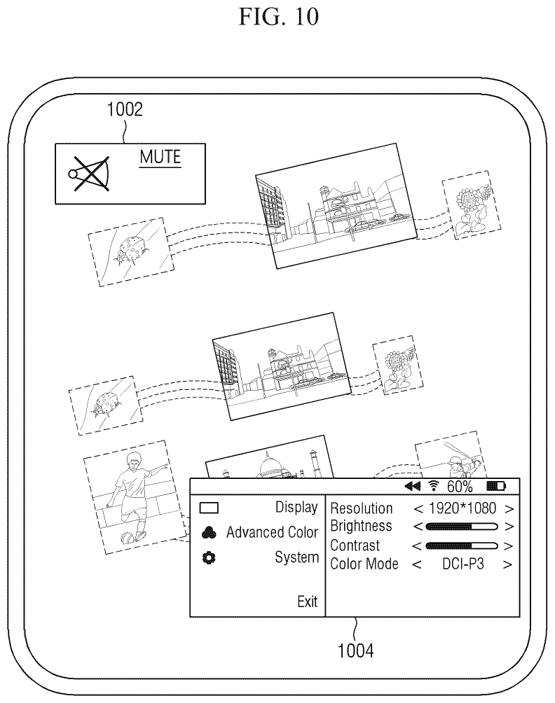

FIG. 10 is a view showing an image of a display screen where an icon and a menu bar are displayed according to one-point and two-point movement sensing.

Referring to FIG. 10, when the display driver circuit 200 determines the user's first interface command according to the one-touch movement position and time, the display driver circuit 200 may display a first screen menu 1002 including a first icon on the screen of the display panel 100, so that a user can check and control the operation control functions, such as muting and powering off the display device 10.

When the display driver circuit 200 determines the user's second interface command according to the touch movement positions and time, the display driver circuit 200 may display a second screen menu 1004 including a second menu bar on the screen of the display panel 100, so that a user can check and control the resolution, the contrast, the color mode, and/or the like of the display device 10.

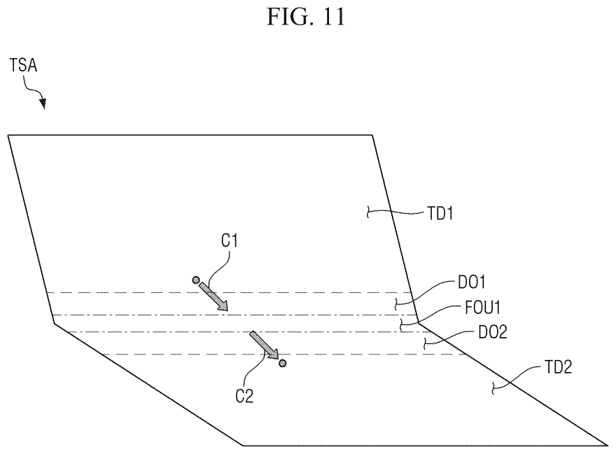

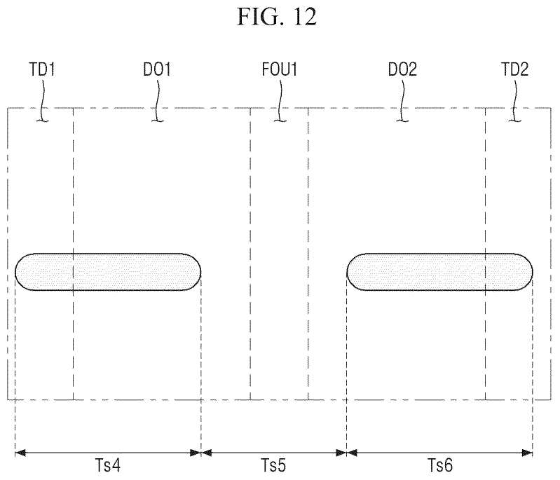

FIG. 11 is a block diagram according to a third embodiment illustrating a folding area, a plurality of planar sensing areas, and a plurality of divided sensing areas that are distinguished from one another in the touch sensing area of FIG. 5. FIG. 12 is an enlarged view showing the first planar sensing area, the first divided sensing area, the folding sensing area, the second divided sensing area, and the second planar sensing area where a user's touch is sensed.

Referring to FIGS. 11 and 12, a user may first touch the first planar sensing area TD1 as shown by an arrow C1, may keep touching while moving to the first divided sensing area DO1, and then may keep touching while moving (e.g., drawing) down to the second divided sensing area DO2 and the second planar sensing area TD2.

Accordingly, the touch driver circuit 400 may transmit to the display driver circuit 200 the touch coordinate data sequentially including the user touch position of the first planar sensing area TD1 and the first divided sensing area DO1, and the touch movement position of the first divided sensing area DO1 and the second planar sensing area TD2.

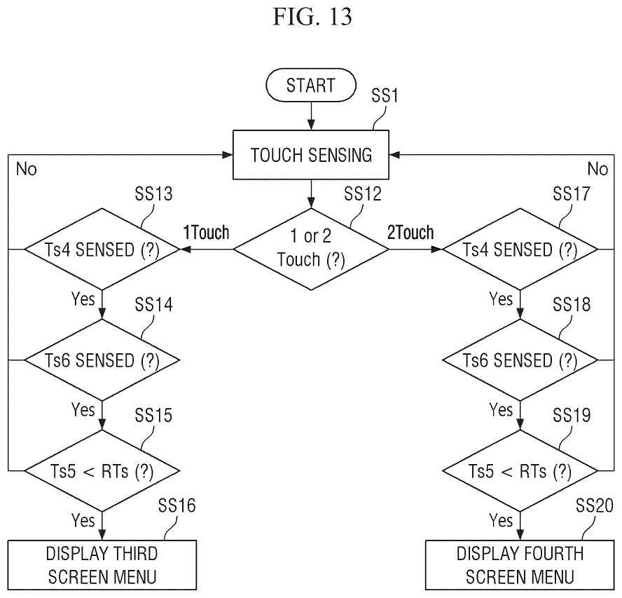

FIG. 13 is a flowchart illustrating a touch sensing process by the touch sensing unit and the touch driver circuit, and a screen menu display process by the display driver circuit.

Referring to FIGS. 12 and 13, the touch driver circuit 400 supplies touch driving signals to the touch electrodes arranged in a matrix structure in the touch sensing unit TSU. Accordingly, the touch driver circuit 400 may detect the touch coordinate data sequentially including the user touch position of the first planar sensing area TD1 and the first divided sensing area DO1, and the touch movement position of the first divided sensing area DO1 and the second planar sensing area TD2 to transmit it to the display driver circuit 200 (SS1).

The display driver circuit 200 checks the touch coordinate data received from the touch driver circuit 400 in real time. If the touch position coordinates on the first planar sensing area TD1 and the first divided sensing area DO1 are sequentially or continuously are identified, the display driver circuit 200 checks the number of touch position coordinates concurrently or substantially simultaneously input and generated with each other to detect the number of one touch or multiple touches generated concurrently or substantially simultaneously with each other (SS12).

If only one touch occurs in the first planar sensing area TD1, the display driver circuit 200 sequentially analyzes the touch coordinates that continuously or sequentially occurs on the first planar sensing area TD1 and the first divided sensing area DO1 to detect the touch movement position and a touch movement time Ts4 in the first planar sensing area TD1 and the first divided sensing area DO1 (step SS13).

To detect the touch movement time Ts4 on the first planar sensing area TD1 and the first divided sensing area DO1, the display driver circuit 200 checks whether or not the touch position coordinates of the second divided sensing area DO2 are detected, and sequentially analyzes the touch coordinates of the second planar sensing area TD2 and the second divided sensing area DO2 to detect the touch movement position and a touch movement time Ts6 in the second planar sensing area TD2 and the second divided sensing area DO2 (SS14).

To detect the touch movement time Ts6 on the second planar sensing area TD2 and the second divided sensing area DO2, the display driver circuit 200 detects a second touch movement time Ts5, which is a time interval between the touch movement time Ts4 in the first planar sensing area TD1 and the first divided sensing area DO1 and the touch movement time Ts6 in the second planar sensing area TD2 and the second divided sensing area DO2. The display driver circuit 200 compares the second touch movement time Ts5 according to the movement of the touch position between the first divided sensing area DO1 and the second divided sensing area DO2 to a reference time information (e.g., a predetermined reference time information) RTs (SS15).

When the second touch movement time Ts5 is less than the reference time information RTs (e.g., if the second touch movement time Ts5 is faster than the reference time information RTs), the display driver circuit 200 determines that it is the user's third interface command. In this case, a third screen menu including a third icon (e.g., a predetermined third icon) or a third menu bar may be displayed on the screen of the display panel 100, so that the user can select or control the built-in features of the display device 10 (SS16).

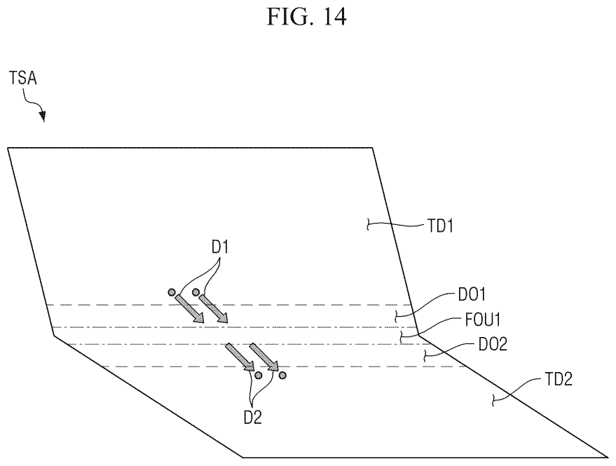

FIG. 14 is a block diagram according to a fourth embodiment illustrating a folding area, a plurality of planar sensing areas, and a plurality of divided sensing areas that are distinguished from one another in the touch sensing area of FIG. 5.

Referring to FIG. 14, a user may first touch the first planar sensing area TD1 and the first divided sensing area DO1 with fingers as shown by an arrow D1, and then may keep touching while moving (e.g., drawing) down to the second divided sensing area DO2 and the second planar sensing area TD2 as shown by an arrow D2.

Referring to FIG. 14 in conjunction with FIG. 13, once the touch position coordinates are identified, the display driver circuit 200 checks the number of touch position coordinates input and generated concurrently or substantially simultaneously with each other to detect the number of one touch or multiple touches generated concurrently or substantially simultaneously with each other (SS12).

If multiple touches occur in the first planar sensing area TD1, the display driver circuit 200 sequentially analyzes one touch coordinates on the first planar sensing area TD1 and the first divided sensing area DO1 to detect the touch movement position and the touch movement time Ts4 in the first planar sensing area TD1 and the first divided sensing area DO1 (SS17).

To detect the touch movement time Ts4 on the first planar sensing area TD1 and the first divided sensing area DO1, the display driver circuit 200 checks whether or not the touch position coordinates of the second divided sensing area DO2 and the second planar sensing area TD2 are detected, and detects the touch movement position and the touch movement time Ts6 in the second divided sensing area DO2 and the second planar sensing area TD2 (SS18).

To detect the touch movement time Ts6 on the second divided sensing area DO2 and the second planar sensing area TD2, the display driver circuit 200 detects a second touch movement time Ts5, which is a time interval between the touch movement time Ts4 in the first planar sensing area TD1 and the first divided sensing area DO1 and the touch movement time Ts6 in the second divided sensing area DO2 and the second planar sensing area TD2. The display driver circuit 200 compares the second touch movement time Ts5 with a reference time information (e.g., a predetermined reference time information) RTs (SS19).

If the second touch movement time Ts5 is less than the reference time information RTs (e.g., if the second touch movement time Ts5 is faster than the reference time information RTs), the display driver circuit 200 determines that it is the user's fourth interface command. In this case, a fourth screen menu including a fourth icon (e.g., a predetermined fourth icon) or a fourth menu bar may be displayed on the screen of the display panel 100, so that the user can select or control the built-in features of the display device 10 (SS20).

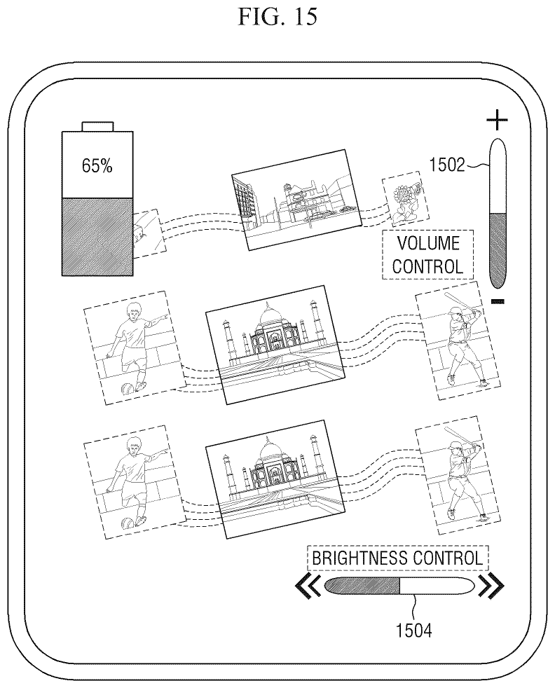

FIG. 15 is a view showing an image of a display screen where icons are displayed according to one-point and two-point movement sensing.

Referring to FIG. 15, when the display driver circuit 200 determines the user's third interface command according to the one-touch movement position and time, the display driver circuit 200 may display a third screen menu 1502 including a third icon on the screen of the display panel 100, so that a user can check and control the operation control functions, such as volume and brightness, of the display device 10.

On the other hand, when the display driver circuit 200 determines the user's fourth interface command according to the touch movement positions and time, the display driver circuit 200 may display a fourth screen menu 1504 including a fourth menu bar on the screen of the display panel 100, so that the user can check and control the brightness, chromaticity, sensitivity, and/or the like of the display device 10.

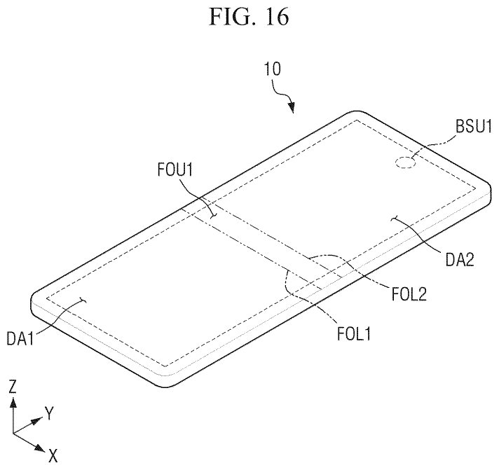

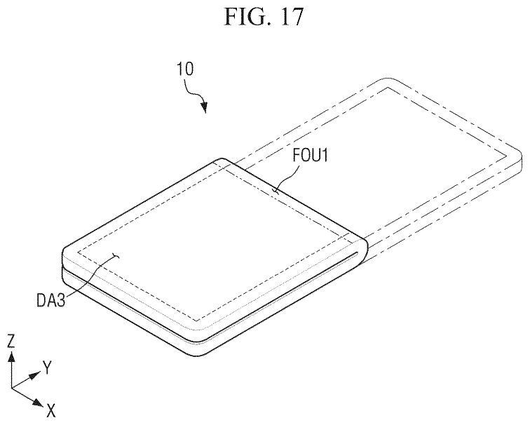

FIG. 16 is a perspective view showing a display device according to another embodiment of the present disclosure. FIG. 17 is a perspective view showing the display device shown in FIG. 16 when folded.

In the example shown in FIGS. 16 and 17, a display device 10 is a foldable display device that may be folded in the second direction (e.g., the y-axis direction). The display device 10 may remain folded or unfolded.

The foldable display device that is folded in the second direction (e.g., the y-axis direction) may also include a first folding area FOU1, a first non-folding area DA1, and a second non-folding area DA2. The first folding area FOU1 may be a part of the display device 10 that can be folded. The first non-folding area DA1 and the second non-folding area DA2 may be parts of the display device 10 that cannot be folded.

The first folding area FOU1 may be disposed along the second direction (e.g., the y-axis direction), and may extend in the first direction (e.g., the x-axis direction). The first non-folding area DA1 may be disposed on one side (e.g., the lower side) of the first folding area FOU1. The second non-folding area DA2 may be located on the opposite side (e.g., on the upper side) of the first folding area FOU1. The first folding area FOU1 may be an area that is bent by a curvature (e.g., a predetermined curvature) at the first folding line FOL1 and the second folding line FOL2. Therefore, the first folding line FOL1 may be a boundary between the first folding area FOU1 and the first non-folding area DA1, and the second folding line FOL2 may be a boundary between the first folding area FOU1 and the second non-folding area DA2. In this case, the first folding area FOU1 may be folded in the second direction (e.g., the y-axis direction), and the first and second non-folding areas DA1 and DA2 may be folded in the second direction (e.g., the y-axis direction) by folding the first folding area FOU1. As another example, the first folding area FOU1 may extend in a diagonal direction of the display device 10 between the first direction (e.g., the x-axis direction) and the second direction (e.g., the y-axis direction). In such case, the display device 10 may be folded in a triangle shape.

When the first folding area FOU1 is extended in the first direction (e.g., the x-axis direction), the length of the first folding area FOU1 in the second direction (e.g., the y-axis direction) may be smaller than the length in the first direction (e.g., the x-axis direction). In addition, the length of the first non-folding area DA1 in the second direction (e.g., the y-axis direction) may be larger than the length of the first folding area FOU1 in the second direction (e.g., the y-axis direction). The length of the second non-folding area DA2 in the second direction (e.g., the y-axis direction) may be larger than the length of the first folding area FOU1 in the second direction (e.g., the y-axis direction).

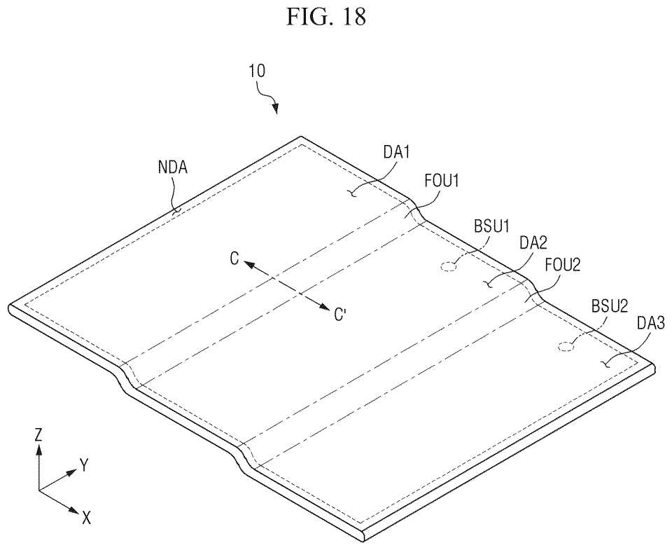

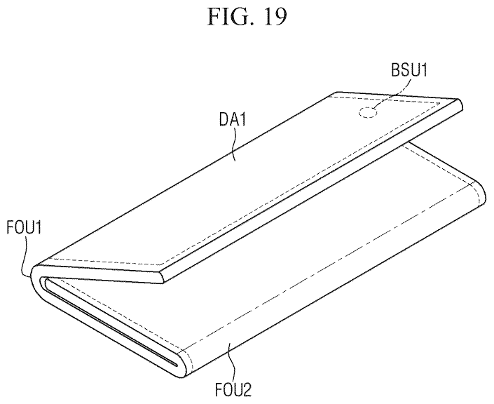

FIG. 18 is a perspective view showing a display device according to another embodiment of the present disclosure. FIG. 19 is a perspective view showing the display device shown in FIG. 18 in a multi-folding state.

In the embodiment shown in FIGS. 18 and 19, a display device 10 may be a multi-foldable display device that can be folded multiple times in the first direction (e.g., the x-axis direction). The display device 10 may remain folded at least once, as well as unfolded. The display device 10 may be folded inward, such that the front surface where the images are displayed is located inside (e.g., an in-folding manner). When the display device 10 is bent or folded in the in-folding manner, a part of the front surface of the display device 10 may face another part of the front surface. As another example, the display device 10 may be folded outward, such that the front surface where the images are displayed is located outside (e.g., an out-folding manner). When the display device 10 is bent or folded in the out-folding manner, a part of the rear surface of the display device 10 may face another part of the rear surface.

The entire image display area of the display device 10 may be divided into a plurality of non-folding areas DA1 to DA3, and one or more folding areas FOU1 and FOU2. As an example, the first and second folding areas FOU1 and FOU2 may be located at different positions from each other along the first direction (e.g., the x-axis direction), and may extend in the second direction (e.g., the y-axis direction). Accordingly, the first and second non-folding areas DA1 and DA2 may be located along the first direction (e.g., the x-axis direction) with the first folding area FOU1 therebetween, and the second and third non-folding areas DA2 and DA2 may be located along the first direction (e.g., the x-axis direction) with the second folding area FOU2 therebetween. In addition, a non-display area NDA may be formed at a border of the entire image display area (e.g., at the borders of the plurality of non-folding areas DA1 to DA3 and the one or more folding areas FOU1 and FOU2).

The first folding area FOU1 may be disposed between the first and second non-folding areas DA1 and DA2, and may extend in the second direction (e.g., the y-axis direction). In addition, the first folding area FOU1 may be folded inward or outward in the first direction (e.g., the x-axis direction). Accordingly, when the first folding area FOU1 is folded outward, the rear surfaces of the first and second non-folding areas DA1 and DA2 may face each other. When the first folding area FOU1 is folded inward, the front surfaces of the first and second non-folding areas DA1 and DA2 may face each other. As such, when the first folding area FOU1 is extended in the second direction (e.g., the y-axis direction) and is folded inward or outward in the first direction (e.g., the x-axis direction), the width of the display device 10 in the first direction (e.g., the x-axis direction) may be reduced to approximately two-third.

The second folding area FOU2 may be disposed between the second and third non-folding areas DA2 and DA3, and may extend in the second direction (e.g., the y-axis direction). In addition, the second folding area FOU2 may be folded inward or outward in the first direction (e.g., the x-axis direction). When the second folding area FOU2 is folded inward, the front surfaces of the second and third non-folding areas DA2 and DA3 may face each other. When the second folding area FOU2 is folded outward, the rear surfaces of the second and third non-folding areas DA2 and DA3 may face each other. As such, when the second folding area FOU2 is extended in the second direction (e.g., the y-axis direction) and is folded inward or outward in the first direction (e.g., the x-axis direction), the width of the display device 10 in the first direction (e.g., the x-axis direction) may be reduced to approximately two-third.

As shown in FIGS. 18 and 19, the display device 10 may be a G-type or inverted G-type foldable display device, in which the first and second folding areas FOU1 and FOU2 are folded inward so that the front surfaces of the second and third non-folding areas DA2 and DA3 face each other, while the front surface of the first non-folding area DA1 faces the rear surface of the third non-folding area DA3. When the G-type or inverted G-type foldable display device is folded, the length of the display device 10 in the first direction (e.g., the x-axis direction) may be reduced to approximately one-third, so that a user can carry the display device 10 more easily.

On the other hand, the multi-foldable display device 10 may be a S-type or inverted S-type foldable display device, in which the first folding area FOU1 is folded outward so that the rear surfaces of the first and second non-folding areas DA1 and DA2 face each other, while the second folding area FOU2 is folded inward so that the front surfaces of the second and third non-folding areas DA2 and DA3 face each other. When the first and second folding areas FOU1 and FOU2 are both folded inward or outward in the S-type or inverted S-type foldable display device, the width of the display device 10 in the first direction (e.g., the x-axis direction) can be reduced to approximately one-third, so that a user can carry the display device 10 more easily.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A portable display device comprising:
a display panel comprising a plurality of planar display areas, and at least one folding area;
a touch sensor on a front surface of the display panel to sense a user's touch;
a touch driver circuit configured to:
divide a touch sensing area of the touch sensor into a plurality of planar sensing areas and at least a folding sensing area; and
detect a touch position and a touch movement position on the plurality of planar sensing areas and the at least one folding sensing area to generate at least one touch coordinate data; and
a display driver circuit configured to analyze a touch position, a touch movement direction, and a touch movement time on the plurality of planar sensing areas and the at least one folding sensing area to display icon or menu bar images on the display panel to enable the user to control a screen control function and an operation control function of the display panel.

2. The display device of claim 1, wherein the touch driver circuit is configured to:
divide the plurality of planar sensing areas overlapping with the planar display areas, respectively, the at least one folding sensing area overlapping with the at least one folding area, and a plurality of divided sensing areas of the plurality of planar sensing areas that is adjacent to the folding sensing area into sizes; and
distinguish them from one another, and
wherein each of the divided sensing areas are divided into an area or a size of 1/n of an area or a size of a corresponding planar sensing area from among the planar sensing areas, wherein n is a positive integer.

3. The display device of claim 2, wherein the display driver circuit is configured to:
analyze the at least one touch coordinate data to detect one touch or a number of multiple touches occurring concurrently with each other;
analyze a touch position in the divided sensing area of each of the plurality of planar sensing areas for the one touch or each number of the multiple touches, a touch movement position, and a touch movement time between adjacent divided sensing areas; and
display the icon or menu bar images on the display panel according to an analysis result of the touch movement position and the touch movement time between the adjacent divided sensing areas.

4. The display device of claim 3, wherein the display driver circuit is configured to:
check the at least one touch coordinate data received from the touch driver circuit; and
when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

5. The display device of claim 4, wherein the display driver circuit is configured to:
detect the touch movement position and the touch movement time in the first divided sensing area by sequentially analyzing the touch coordinates of the first divided sensing area for one touch coordinate data generated by one touch in the first divided sensing area;
check whether the touch position coordinates of a second divided sensing area of a second planar sensing area from among the planar sensing areas that is adjacent to the first divided sensing area are detected to detect the touch movement position and the touch movement time in the second divided sensing area;
detect a first touch movement time, which is a time interval between the touch movement time in the first divided sensing area and the touch movement time in the second divided sensing area; and
determine a first interface command for the user when the first touch movement time is less than a reference time information to display a first screen menu on the display panel as the icon or menu bar images.

6. The display device of claim 4, wherein the display driver circuit is configured to:
detect the touch movement position and the touch movement time in the first divided sensing area by sequentially analyzing the touch coordinates of the first divided sensing area for multiple touch coordinate data generated by multiple concurrent touches in the first divided sensing area;
check whether the touch position coordinates of a second divided sensing area of a second planar sensing area from among the planar sensing areas that is adjacent to the first divided sensing area are detected to detect the touch movement position and touch movement time in the second divided sensing area;
detect a second touch movement time, which is a time interval between the touch movement time in the first divided sensing area and the touch movement time in the second divided sensing area; and
determine a second interface command for the user when the second touch movement time is less than a reference time information to display a second screen menu on the display panel as the icon or menu bar images.

7. The display device of claim 2, wherein the display driver circuit is configured to:
analyze the at least one touch coordinate data to detect one touch or a number of multiple touches occurring concurrently with each other;
analyze a touch position in the plurality of planar sensing areas and the divided sensing area of each of the plurality of planar sensing areas for each of the one touch or the number of the multiple touches, a touch movement position, and a touch movement time between adjacent divided sensing areas; and
display the icon or menu bar images on the display panel according to an analysis result of the touch movement position and the touch movement time between the adjacent divided sensing areas.

8. The display device of claim 7, wherein the display driver circuit is configured to:
check the at least one touch coordinate data received from the touch driver circuit; and
when touch position coordinates on a first planar sensing area from among the plurality of planar sensing areas and a first divided sensing area of the first planar sensing area are detected, check a number of touch position coordinates input and generated concurrently with each other to detect the one touch or the number of multiple touches that occurred concurrently with each other.

9. The display device of claim 8, wherein the display driver circuit is configured to:
detect the touch movement position and the touch movement time in the first planar sensing area and the first divided sensing area by sequentially analyzing the touch coordinates connected to the first planar sensing area and the first divided sensing area for touch coordinate data generated by one touch in the first planar sensing area;
check whether the touch position coordinates of a second planar sensing area adjacent to the first planar sensing area and a second divided sensing area of the second planar sensing area are detected to detect the touch movement position and touch movement time connected to the second planar sensing area and the second divided sensing area;
detect a third touch movement time, which is a time interval between the touch movement time in the first planar sensing area and the first divided sensing area and the touch movement time in the second planar sensing area and the second divided sensing area; and
determine a third interface command for the user when the third touch movement time is less than a reference time information to display a third screen menu on the display panel as the icon or menu bar images.

10. The display device of claim 8, wherein the display driver circuit is configured to:
detect the touch movement position and the touch movement time in the first planar sensing area and the first divided sensing area by sequentially analyzing the touch coordinates connected to the first planar sensing area and the first divided sensing area for multiple touch coordinate data generated by multiple concurrent touches in the first planar sensing area;
check whether the touch position coordinates of a second planar sensing area adjacent to the first planar sensing area and a second divided sensing area of the second planar sensing area are detected to detect the touch movement position and the touch movement time connected to the second planar sensing area and the second divided sensing area;
detect a fourth touch movement time, which is a time interval between the touch movement time in the first planar sensing area and the first divided sensing area and the touch movement time in the second planar sensing area and the second divided sensing area; and
determine a fourth interface command for the user when the fourth touch movement time is less than a reference time information to display a fourth screen menu on the display panel as the icon or menu bar images.

11. A portable display device comprising:
a display panel comprising a plurality of planar display areas, and at least one folding area;
a touch sensor on a front surface of the display panel to sense a user's touch;
a touch driver circuit configured to:
divide a touch sensing area of the touch sensor into a plurality of planar sensing areas overlapping with the planar display areas, and at least a folding sensing area overlapping with the at least one folding area; and
detect a touch position and a touch movement position on the plurality of planar sensing areas and the at least one folding sensing area to generate at least one touch coordinate data; and
a display driver circuit configured to analyze a touch position, a touch movement direction, and a touch movement time on the plurality of planar sensing areas and the at least one folding sensing area to display icon or menu bar images on the display panel to enable a user to control a screen control function and an operation control function of the display panel,
wherein the touch driver circuit is configured to:
divide a plurality of divided sensing areas that is adjacent to the folding sensing area into sizes for each of the plurality of planar sensing areas; and
distinguish the plurality of planar sensing areas from the folding sensing area for each of the plurality of planar sensing areas to detect the touch position.

12. The display device of claim 11, wherein the display driver circuit is configured to:
analyze the at least one touch coordinate data to detect one touch or a number of multiple touches occurring concurrently with each other;
analyze a touch position in the divided sensing area of each of the plurality of planar sensing areas for each one touch or the number of multiple touches, a touch movement position, and a touch movement time between adjacent divided sensing areas; and
display the icon or menu bar images on the display panel according to an analysis result of the touch movement position and the touch movement time between the adjacent divided sensing areas.

13. The display device of claim 12, wherein the display driver circuit is configured to:
check the at least one touch coordinate data received from the touch driver circuit; and
when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

14. The display device of claim 13, wherein the display driver circuit is configured to:
check the at least one touch coordinate data received from the touch driver circuit; and
when touch position coordinates on a first divided sensing area of a first planar sensing area from among the planar sensing areas are identified, check a number of touch position coordinates input and generated concurrently with each other to detect the one touch or the number of multiple touches that occurred concurrently with each other.

15. The display device of claim 12, wherein the display driver circuit is configured to:
analyze the at least one touch coordinate data to detect one touch or a number of multiple touches occurring concurrently with each other;
analyze a touch position in the plurality of planar sensing areas and the divided sensing area of each of the plurality of planar sensing areas for each of the one touch or the number of multiple touches, a touch movement position, and a touch movement time between adjacent divided sensing areas; and
display the icon or menu bar images on the display panel according to an analysis result of the touch movement position and the touch movement time between the adjacent divided sensing areas.
